(19) United States
(12) Patent Application Publication
(10) Pub. No.: US 2024/0020729 A1
(43) Pub. Date: Jan. 18, 2024

(54) SYSTEM OF CAPTURING ONLINE ADVERTISEMENTS FOR LATER VIEWING AND INTERACTION AND METHOD OF USING THE SAME

(71) Applicant: Louder.ai, Inc., Louder.ai, Inc., MA (US)

(72) Inventor: Keith Ablow, Newburyport, MA (US)

(21) Appl. No.: 17/862,636

(22) Filed: Jul. 12, 2022

(51) Int. Cl. G06Q 30/02; G06Q 10/10

(52) U.S. Cl. CPC G06Q 30/0249; G06Q 30/0277; G06Q 10/1053; G06Q 30/0242

(57) ABSTRACT

Provided are embodiments of a system and method for capturing online advertisements for later viewing and interaction. The method includes: displaying an advertisement associated with an interest or an interested party on a GUI accessible by a receiving party via a PED, and displaying a first icon or image positioned within or adjacent to the advertisement on the GUI that indicates the advertisement can be saved by the receiving party and moved into a user pocketbook configured to allow future viewing and interaction therewith. The method further includes registering a user input by the receiving party indicating the user wants to move the advertisement to the user pocketbook; and moving the advertisement into the user pocketbook in response to registering the user input. Additional embodiments provide for a user to fund the further propagation of a captured advertisement and to be rewarded relative to a number of impressions.

### FIELD OF THE INVENTION

The present disclosure relates generally to advertising. More specifically, the present disclosure relates to a system for capturing online advertisements for later viewing and interaction, and a method of using the same.

### BACKGROUND

People encounter countless advertisements on a daily basis, often both virtually and non-virtually. Various computing systems have been created to operate in a network environment and provide opportunities for consumers to cache, tag, and exchange various network-accessible content. However, users of such systems are not currently able to capture advertisements they have seen virtually as well as those seen or experienced out of a network environment and consolidate all such advertisements into a user pocketbook for their later viewing and interaction. That is, no current technology combines the capture of advertisements presented on an electronic media device (e.g. via an online advertisement such as those found on YouTube) and those displayed on static or real world medium such as a billboard or banner. Moreover, people are not provided the opportunity to interact with advertisements from such a user pocketbook and to earn rewards for doing so.

Accordingly, there exists a need to provide a way for users of a system to capture advertisements in a user pocketbook for later viewing and interaction. Users should also be provided a way to become donors or affiliate marketers regarding such advertisements so they can contribute in a meaningful way to further their chosen causes and campaigns.

### SUMMARY

An embodiment of the disclosure provides a method of capturing online advertisements for later viewing and interaction, the method comprising: displaying, using a processor connected to a network, a first advertisement associated with at least one of an interest and an interested party, wherein the displaying of the first advertisement is on a graphical user interface accessible by a receiving party via a web browser or a mobile application on a personal electronic device; and displaying, using the processor, a first icon or first image positioned within or adjacent to the first advertisement on the graphical user interface that indicates the first advertisement can be saved by the receiving party and moved into a user pocketbook configured to allow future viewing and interaction with the first advertisement. The method further includes registering, using the processor and in response to a user input on a personal electronic device, a selection by the receiving party indicating the receiving party wants to move the first advertisement to the user pocketbook; and moving, using the processor connected to the network, the first advertisement into the user pocketbook in response to registering the user input.

An embodiment of the disclosure provides a system for capturing online advertisements for later viewing and interaction, the system comprising: a processor; a graphical user interface in communication with the processor; and at least one non-transitory program storage device in communication with the processor via a network. The graphical user interface is accessible by a receiving party via a web browser or mobile application on a personal electronic device; and the processor is configured to communicate with the at least one non-transitory program storage device and the graphical user interface to execute instructions for: displaying, on the graphical user interface, a first advertisement associated with at least one of an interest and an interested party; and displaying, within or adjacent to the first advertisement on the graphical user interface, a first icon or first image which indicates that the first advertisement can be saved by the receiving party and moved into a user pocketbook configured to allow future viewing and interaction with the first advertisement. The system further includes instructions for registering, in response to a user input on the personal electronic device, a selection by the receiving party indicating the receiving party wants to move the first advertisement to the user pocketbook; and moving the first advertisement into the user pocketbook in response to registering the user input.

An embodiment of the disclosure provides a method of capturing online advertisements for later viewing and interaction, the method comprising: displaying, using a processor connected to a network, a first advertisement associated with at least one of an interest and an interested party, wherein the displaying of the first advertisement is on a graphical user interface accessible by a receiving party via a web browser or a mobile application on a personal electronic device; displaying, using the processor, a first icon or first image positioned within or adjacent to the first advertisement on the graphical user interface that indicates the first advertisement can be saved by the receiving party and moved into a user pocketbook configured to allow future viewing and interaction with the first advertisement; registering, using the processor and in response to a user input on a personal electronic device, a selection by the receiving party indicating the receiving party wants to move the first advertisement to the user pocketbook; and moving, using the processor connected to the network, the first advertisement into the user pocketbook in response to registering the user input. In this embodiment, the user pocketbook comprises a user account that is associated with the receiving party and a user profile associated with the user account, wherein the receiving party can customize or personalize at least one portion or parameter of the user pocketbook, and wherein the first advertisement is associated with at least one of a retail product or a service and the at least one of the interest or interested party is a manufacturer or interested business. The method further includes: displaying, using the processor connected to the network, a second icon or second image positioned within or adjacent to the first advertisement on the user feed, wherein the second icon or second image indicates the first advertisement is a fundable advertisement and the receiving party can become an affiliate marketer for the manufacturer or interested business by paying a monetary contribution to fund further propagation of the first advertisement; registering, using the processor and in response to a second user input on the personal electronic device, a second selection by the receiving party which indicates a fixed amount of currency as the monetary contribution; and performing, using the processor connected to the network, a transfer of the fixed amount of currency from a first financial account associated with the affiliate marketer to a second financial account designated to hold funds to fund the further propagation of the first advertisement. The method includes creating, using the processor and in response to completion of the transfer of the fixed amount of currency, a second advertisement, wherein the second advertisement appears identical to the first advertisement and has been tagged with a blockchain code configured to identify an ownership interest of the affiliate marketer; and projecting, via the advertising medium, the second advertisement comprising the blockchain code. The method also includes the additional operations of tracking, using the processor and the blockchain code, impressions made upon other users who interact with the second advertisement; and rewarding, via the processor, the affiliate marketer with a reward configured to correspond to at least one of an amount of impressions and a value of impressions made upon the other users.

### BRIEF DESCRIPTION OF THE DRAWINGS

Having thus described examples of the disclosure in general terms, reference will now be made to the accompanying drawings, which are not necessarily drawn to scale, and wherein like reference characters designate the same or similar parts throughout the views. The particular objects and features of the instant disclosure as well as the advantages related hereto will become apparent from the following description taken in connection with the accompanying drawings, and wherein:

FIG. 1 is a flowchart illustrating a method of capturing advertisements for later viewing or interaction according to an embodiment of the disclosure;

FIG. 2 is a flowchart illustrating a method of capturing advertisements for later viewing or interaction according to another embodiment of the disclosure;

FIG. 3 is a flowchart illustrating a method of capturing advertisements for later viewing and interaction according to an embodiment of the disclosure;

FIG. 4 is a block diagram illustrating a system of capturing advertisements according to an embodiment of the disclosure; and

FIG. 5 is a block diagram illustrating a system of capturing online advertisements according to an embodiment of the disclosure.

### DETAILED DESCRIPTION

The following description of the embodiments of this disclosure is intended to enable someone skilled in the prior art to make and use that which is disclosed, but is not intended to limit the claims to these particular exemplary embodiments.

In general, embodiments of the disclosure relate to a system and method for allowing users to capture online advertisements and save them in a user pocketbook or folder on a user device. The user can later view and/or interact with the captured advertisements within the user pocketbook. Moreover, a user can link a financial account to a user profile associated with the user pocketbook and directly fund the propagation of an advertisement or communication that is associated with a chosen cause, interest, or campaign.

In an embodiment, users, individuals, groups, or companies can interact with the advertisements found in their respective user pocketbooks accessible on a personal electronic device (“PED”). As used throughout the disclosure, a PED may include a device with a computer processor, a personal digital assistant (“PDA”), a laptop or desktop computer, a tablet, an iPad, a smart phone, a mobile phone, a camera, an electronic watch, a tablet, smart glasses, virtual reality (VR) goggles, VR headsets, and head-up displays, or a similar PED having network connectivity enabled therein. A head-up display being defined as any transparent display that presents data without requiring a user to look away from their usual viewpoints.

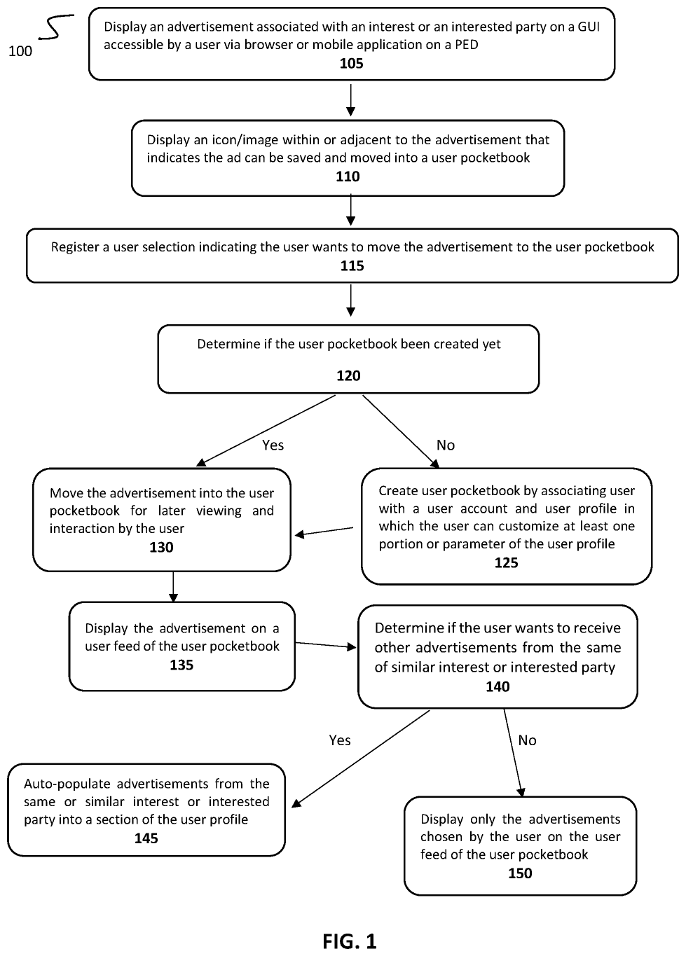

Referring now to FIG. 1, a flow chart illustrating a method according to an embodiment of the disclosure is shown. Each block or operational step illustrated in the flow chart, and combinations thereof, can be implemented by means of an analog or digital hardware and computer program instructions. These program instructions can be provided to a processor of a general purpose computer, special purpose computer, application-specific integrated circuit, or other programmable data processing apparatus, such that the instructions, which execute via the processor of the computer or other programmable electronic device, implements the operations/functions/acts/steps specified in the block diagrams, operation block(s), and/or alternate embodiments, the operations, functions, steps, and/or acts noted in the blocks may be implemented in a modified order, such as at least substantially concurrently, backwardly, forwardly, or otherwise. The flowcharts illustrated herein are intended to provide a better understanding of the disclosure herein, but do not exclude other embodiments pertaining to an order of the same or embodiments comprising additional operations or such.

As illustrated in FIG. 1, an overview of an embodiment of a method 100 of capturing online advertisements for later viewing or interaction is illustrated. The method begins with a processor displaying an advertisement on a graphical user interface (“GUI”) via a network (Operation 105). The graphical user interface is accessible by a user via a web browser or a mobile application on a PED. As disclosed herein, an advertisement is associated with an interest or an interested party, such as a charity, charity event, cause, project, political campaign, marketing campaign, and/or an individual or group of people associated therewith. The cause or campaign can be associated with, for example, a human rights issue, a political party, a religious preference or affiliation, a personal opinion or stance on a public issue, a business-related cause, project, or marketing campaign, or a personal matter. In various embodiments, the advertisement can be any form of communication such as a posting, a notice, or an announcement promoting a product, a service, an event, an opinion, a religious affiliation, a political campaign ad, a meme, or any type of message that is intended to inform, influence, entertain, or educate people that receive, see, or interact with the communication. The terms “communication” and “advertisement” are used interchangeably throughout this disclosure and are intended to include any and all types of messages as set forth herein and all other terms known by those of ordinary skill in the art as being included or related thereto. A communication can be a visual or audio communication or both.

The method of capturing online advertisements for later viewing or interaction can further include the processor displaying an icon or image positioned within or adjacent to the advertisement on the graphical user interface that indicates that the advertisement can be saved and moved into a user pocketbook (Operation 110). As used throughout the instant disclosure and as known by those of ordinary skill in the art, an icon or icon button is a little picture or image that can lead to an action when a user interacts with it through a user interface (e.g. clicking the icon with a mouse associated with a computer or laptop, or clicking the icon via a touchpad or touchscreen on a laptop). In an embodiment, the icon can simply include a picture with no text. In another embodiment, an icon may include text but no picture. In some embodiments, an icon may be a button including text indicating an amount of a monetary contribution or currency. In other embodiments, the icon may include a QR code or any similar matrix barcode that allows for a camera or QR code reader application to identify and associate with an advertisement and/or company. In an embodiment, the image may be a URL link or hyperlink that brings a user to a website upon selection thereof, for example, by clicking a mouse thereupon or by pressing a combination of keys from a keyboard and/or clicking buttons on a mouse (e.g. simultaneously holding down the “control” key and left-click using a mouse, or right-click on the hyperlink and select “open hyperlink” from the shortcut menu that displays, etc).

Next, the method may include registering a selection by the user indicating the user wants to move the advertisement into the user pocketbook (Operation 115). A determination must be made as to whether the user pocketbook has been created already (Operation 120). If the user pocketbook has not been created yet, the method proceeds with creation of the user pocketbook (Operation 125). The creation of the user pocketbook may include associating on the graphical user interface, a user account with the receiving party and a user profile associated with the user account. As an aside, the terms “user” and “receiving party” are used interchangeably throughout the disclosure, as a user of the system may be a receiving party of an advertisement and visa versa. In an embodiment, the user can customize or personalize at least one portion or parameter of the user pocketbook. For example, a user may be able to customize a layout of the user pocketbook or choose a specific color scheme. Multiple other examples of customization of the portions and/or parameters of user profiles are known to those of ordinary skill in the art. These include, but are not limited to, selecting fonts, colors, designs, and/or pictures to include within a user profile. In an embodiment, creation of the user pocketbook may further include allowing the user to select whether they want to receive other advertisements from a same or similar interest or interested party as that which is associated with the selected advertisement (Operation 140). Such other advertisements from the same or similar interest or interested party may be auto-populated into a section of the user feed (Operation 145). The auto-populated section may be updated periodically or according to a fixed schedule or period of time. In another embodiment, the user may be able to view a list of similar interests or interested parties from which to select from and only advertisements related to those particular selected interests or interested parties may be auto-populated into a section of the user feed. Alternatively, if the user opts not to receive other advertisements similar to the recently selected advertisement, the user feed will only display the advertisements selected by the user to be moved into the feed of the user pocketbook (Operation 150).

Once a user pocketbook has been created, the advertisement selected by the user may be moved into the user pocketbook in response to registering the user input (Operation 130). After the advertisement is moved into the user pocketbook, the advertisement is displayed on the user feed of the user pocketbook (Operation 135).

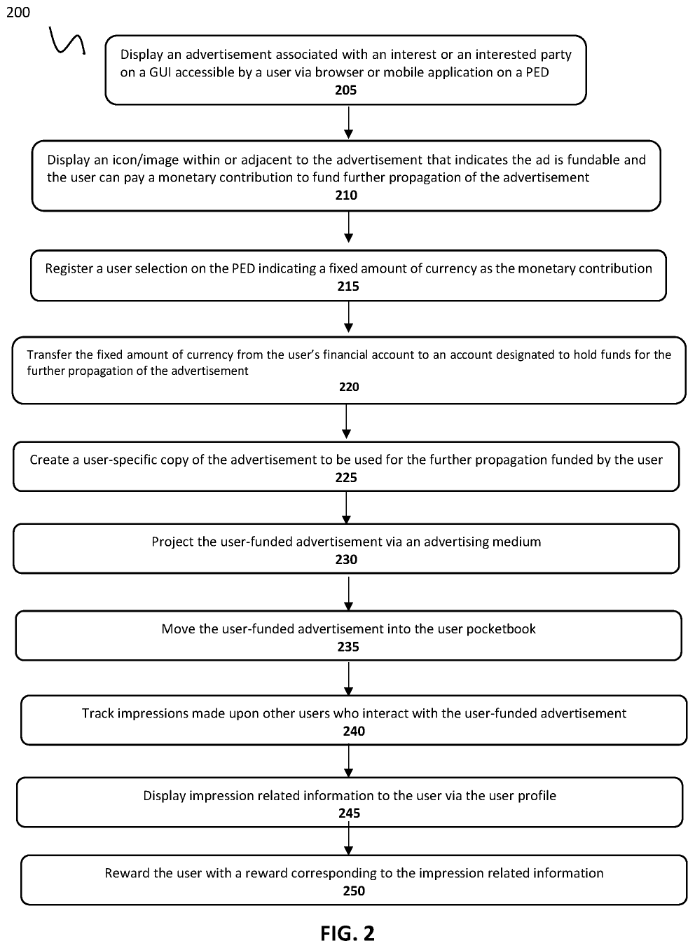

Referring now to FIG. 2, an embodiment of the method 200 may include the operational steps of FIG. 1 and include display of an advertisement associated with an interest or an interested party on a GUI accessible by a user via browser or mobile application on a PED (Operation 205). The method may further include display of an icon or image within or adjacent to the advertisement that indicates the advertisement is fundable and the user can pay a monetary contribution to fund further propagation of the advertisement (Operation 210). That is, a user seeing any advertisement displayed with this particular icon or image will know that it is possible to pay money to further propagate the advertisement. Stated differently, a user may decide to support the cause or interest related to the advertisement by paying for others to receive the same message. In an embodiment, this icon indicating an advertisement is fundable may be different than and/or separate from the icon that indicates the advertisement can be captured and moved into the user pocketbook. In another embodiment, the icon indicating an advertisement is fundable may be a portion of the icon referenced in FIG. 1 which indicates that the advertisement can be saved and moved into a user pocketbook. In yet another embodiment, the icon indicating an advertisement can be saved and moved into a user pocketbook may be a portion or part of the icon of Operation 210 which indicates the advertisement is fundable.

The method further includes the processor registering, in response to a user input on a PED, a selection by the user which indicates a fixed amount of currency as a monetary contribution (Operation 215). A user seeing the fundable advertisement may choose to fund the advertisement by selecting or clicking the icon or a portion thereof and further indicating a fixed amount of currency as the desired monetary contribution.

In an embodiment, the processor performs a transfer of the fixed amount of currency from a financial account associated with the user to a financial account designated to hold funds for the further propagation of the fundable advertisement (Operation 220). In an embodiment, the second financial account is dedicated to a group financial account for crowdfunding for the further propagation of the fundable advertisement.

After performing the transfer of funds from the user's financial account to another account, the method includes projecting the user-funded advertisement via an advertising medium (Operation 230). In some embodiments, the further propagation of the funded advertisement may happen almost instantaneously with the transfer of funding; while in other embodiments of the disclosure, the projecting of the advertisement funded by the user may happen at a different time or over a period of time.

In an embodiment of the disclosure, a user-specific copy of the advertisement may be created after the transfer of funds from the user's financial account (Operation 225), and the user-specific copy of the advertisement may be the version of the advertisement that is projected via an advertising media in correlation to the amount of money the user contributed to fund the advertisement's further propagation. In an embodiment, the user-specific copy of the advertisement may be moved into the user pocketbook (Operation 235).

The advertising medium for the projecting of the user-funded communication can include various ad channels. These ad channels include print media, digital billboards, terrestrial billboards, radio advertisements, TV advertisements, over-the-top (OTT) media services including media services directly to viewers via the internet, SMS campaigns enabling interaction with users via text, offline advertising media, digital advertising media, virtual advertising media, social networking, targeted emails, embedded video advertisements, and any other ad channels known by those of ordinary skill in the art.

The method illustrated in FIG. 2, further includes the operations of tracking impressions made upon other users who interact with the user-funded advertisement (Operation 240) and displaying impression-related information to the user via the user profile (Operation 245). In various embodiments, the method includes rewarding the user with a reward corresponding to the impression related information (Operation 250).

In various embodiments of the disclosure, the processor registers an action by the user that causes the processor to display the fundable advertisement on the user feed. The user's action could be any number of actions and in some embodiments, may depend, in part, on the ad channel where the user received or initially interacted with the advertisement. In an embodiment, the user's action includes selecting, via a PED, the icon displayed within or adjacent to the first communication on the graphical user interface. In another embodiment of the disclosure, the user's action includes taking a picture of or scanning a QR code associated with the fundable advertisement using a PED.

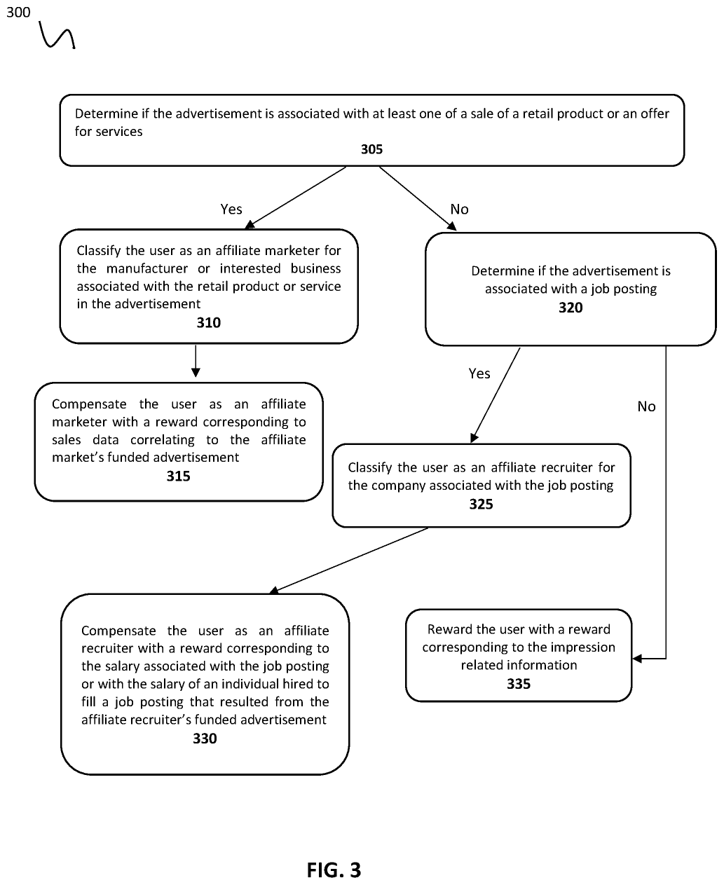

Referring now to FIG. 3, an embodiment of the disclosed method 300 includes some or all of the operations illustrated in FIG. 1 and FIG. 2 plus various additional operations that are dependent upon the type of advertisement that is fundable and/or that a user decides to fund. The method may include determining whether the advertisement is associated with at least one of a sale of a retail product or an offer for services (Operation 305). If it is determined that the advertisement is associated with at least one of a sale of a retail product or an offer for services, then a user who funds the advertisement may become an affiliate marketer for the manufacturer or interested business associated with the retail product or service in the advertisement (Operation 310). Further, the user may be compensated for being an affiliate marketer with a reward corresponding to sales data correlating to the affiliate marketer's funded advertisement (Operation 315).

Alternatively, if it is determined in Operation 305 that the advertisement is not associated with at least one of a sale of a retail product or an offer for services, the method continues with determining, using the processor connected to the network, whether the advertisement is associated with a job posting for a company, business, or individual (Operation 320). If it is determined that the advertisement is associated with a job posting, then a user who funds the advertisement may become an affiliate recruiter for the company, business, or individual associated with the job posting (Operation 325). The user may be compensated for being an affiliate recruiter with a reward corresponding to the salary associated with the job posting or with the salary of an individual hired to fill a job posting or position that resulted from the affiliate recruiter's funded advertisement (Operation 330).

If it is determined that the advertisement is not associated with at least one of a sale of a retail product or an offer for services and it is also not associated with a job posting or job opening, then the user may be rewarded with a reward corresponding to the impression-related information (Operation 335).

In an embodiment, the method includes allowing a cause or interest to create a user account and allowing the cause to identify or designate an advertisement as being fundable or as being fundable only during a specified period of time. Thus, a user of the disclosed system may be a donor, contributor, citizen, group of citizens, company, group of companies, or the like; and a user may also be a cause or a party associated with the cause. A user account is created by the user and is utilized by the user to engage with the graphical user interface which encourages and permits users to interact with one another. This may include donors finding charities to selectively donate to, as well as charities or causes interacting with the donor users or with each other. In general, a user may engage in social activities whether he or she is collecting and saving advertisements into the user pocketbook for his or her later viewing and interaction only, whether he or she is funding advertisements regardless of the purpose, whether he or she is funding advertisements that are associated with a sale of goods or offer of services and the user becomes an affiliate marketer, whether he or she is funding an advertisement associated with a job opening or job posting and the user becomes an affiliate recruiter, whether the user is interested in funding other types of advertisements, and/or if the user is associated with one or more of the advertisements that are capturable and/or fundable according to the disclosed system.

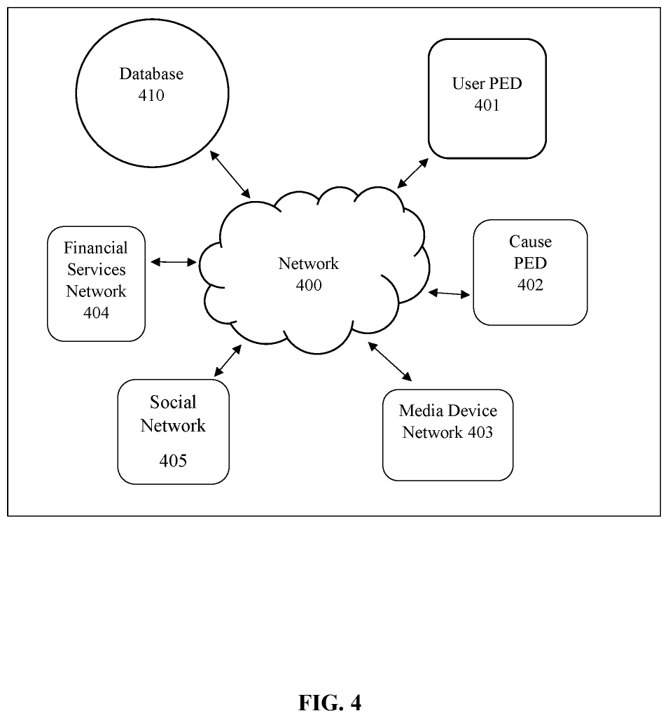

FIG. 4 illustrates a network configuration of an embodiment of the disclosure. Network 400 is in communication with a user PED 401, a cause PED 402, a media device network 403, a financial services network 404, and a social network 405. Each device within the network may send and receive information. A database 410 may store information as well as send and receive information throughout the network 400.

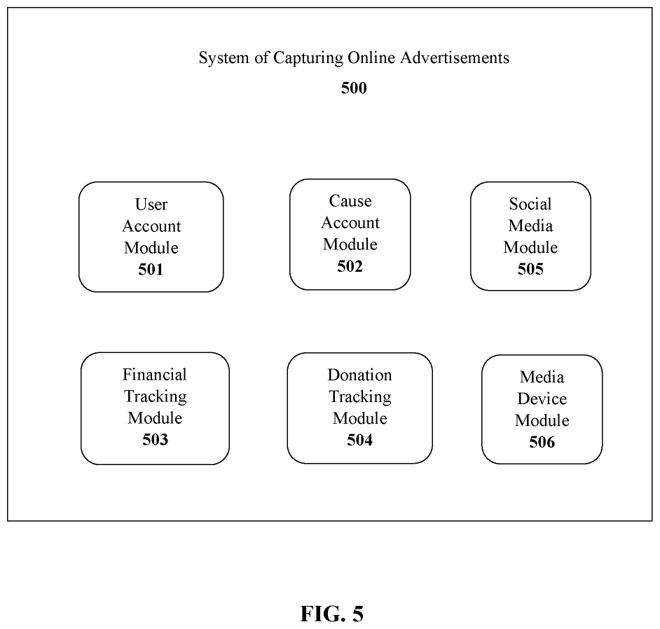

In an embodiment, the various disclosed operations, such as those illustrated in FIGS. 1, 2, and 3 are performed by a plurality of modules as illustrated in FIG. 5. The system of capturing online advertisements 500, includes a user account module 501, a cause account module 502, a financial tracking module 503, a donation tracking module 504, a social media module 505, and a media device module 506, all of which communicate with one or more processors in order to execute functionalities and features of the disclosure.

In an embodiment, the user account module 501 and the cause account module 502 communicate with the user's PED 401 allowing for registration, donations, funding of advertisements, social networking, and other functionalities associated with the system 500. The financial tracking module 503 communicates with the financial network and receives transaction data regarding user transactions. The donation tracking module 504 identifies the cause and the specific fundable advertisement which the donation is directed towards and associates the appropriate cause and fundable advertisement with the appropriate user that donated the funds for the further propagation of that advertisement.

The system promotes user to user interactions as a means of promoting user participation throughout the network. Whether the user is a donor or whether the user is a cause or interested party associated with the cause, user profiles are viewable throughout the network as determined by user privacy settings which are standard in the art.

To access and begin utilizing the network, a registration engine may be utilized to create an account. Once activated, the user may use their PED to access their user pocketbooks via a GUI by inputting credentials including a username, password, or similar implements. Once credentials are validated, any number of selectable panels, or graphical displays may be illustrated, each having specific account information related to the user, or other users in the network.

As discussed above regarding embodiments of the disclosed method of capturing online advertisements, the system creates a user pocketbook in response to a user input on a PED. The system associates a user account on the GUI accessible to the user via an online browser or mobile application on the PED. A user profile is associated with the user account and the user can customize or personalize any of a number of places or portions visible in the user profile in addition to various parameters of the user pocketbook. The user profile may include various user information such as a chosen username, user photos, user personal information, and/or a list or showing of the advertisements the user has captured and moved into the user pocketbook to view or interact with later. The user profile may include a section listing or showing the advertisements that the user has funded, a total amount of contributions the user has made toward specific funded advertisements or a cumulative number or sum of contributions the user has made to fund advertisements associated with a particular interest or interested group, and a total number of impressions made upon other users who interacted with an advertisement the user funded. User personal information, in various embodiments, may include user contact information, core values, education details or college degrees attained by the user, volunteer groups, religious affiliation, political affiliation, or any other information that the user may wish to share publicly. The types of user information may be similar to those found in social networking profiles or other profiles associated with social or professional organizations and their networks.

As is standard in the relevant arts, the GUI may include navigational tools such as an information tool bar which may include links to various pages within the user pocketbook or places in the GUI and can provide information about the part of the GUI which a user is currently viewing. Via a user feed on the user profile a user can view and interact with advertisements that have been captured and/or funded by the user. In an embodiment, the user feed may include a posting tool which allows the user to post new information to the network and allows the user to see postings from other users.

In an embodiment, the system may include instructions for allowing, via the user profile, the user to send personal messages back and further between one or more users on the network, wherein these personal messages are only viewable by the users specifically involved in that conversation. In an embodiment, the system may include instructions for allowing one user to “follow” another user and to be notified when the user makes any monetary contributions, funds, or otherwise further propagates an advertisement, as per the privacy settings of users involved.

In an embodiment, the system includes allowing, via the user profile, the user to designate a userID that will be included on or near a user-funded advertisement when it is further propagated using the user's monetary contribution, wherein the userID identifies the user or the user's account.

An embodiment of the disclosure includes displaying, on the user profile, an indication of a total amount of impressions made upon other users who interacted with the user-funded advertisement. In another embodiment, the system may include displaying, on the user profile, a list of other users who have further funded the same advertisement the user funded.

An embodiment of the disclosure includes providing the user with an opportunity to forward a posting or announcement about the monetary contribution to the user's contacts via social networks, to other user accounts in the disclosed system, and/or to a user's contacts in a personal network such as contacts in a phone. In an embodiment, the funding system disclosed herein may automatically, with user permission or settings, post a message or other notification regarding the transaction via a social network or other designated network. Another embodiment may allow a user to notify other users as to a monetary contribution that was made for a same or similar fundable advertisement.

Additional embodiments of the disclosure may include a system with instructions for displaying on the user profile, a plurality of ad channels that may be utilized for the further propagation of the fundable advertisement. In an embodiment, the user may be allowed to choose the advertising medium from the plurality of ad channels for the propagation or dissemination of the advertisement the user funds.

In various embodiments of the disclosure, the fixed amount of currency for a user's monetary contribution can be in the form of money, tokens, digital currency, and cryptocurrency.

In various embodiments, the system may be gamified and allow a user to compete with one or more other users for a highest number of advertisements funded. In an embodiment, the gamified system may allow a user to compete with other users based on a total amount of impressions made upon other users who interacted with the user's funded advertisement or based upon other impression-related data.

In an embodiment, a user may be able to receive money or tokens or some other kind of tangible or virtual compensation as a result of participating in a gamified event with other users. In an embodiment, the user may be able to put a user reward toward a further propagation of a chosen fundable advertisement instead of accepting a tangible or virtual compensation.

Various embodiments of the disclosure include creative and complex methods of rewarding a user for causing and/or funding further propagation of an advertisement. In an embodiment, a user may be rewarded for further propagating an advertisement even if the user didn't pay a positive fixed amount of currency for the further propagation. Stated differently, in an embodiment of the disclosure, a user's monetary contribution may be a fixed amount of currency equal to zero (0) dollars. In various other embodiments, the user's monetary contribution may be a fixed amount of currency that is greater than zero (0) dollars (e.g. $5, $10, $20, $100, $500, etc.).

In an embodiment wherein the advertisement is associated with at least one of a sale of a retail product and an offer for services, a user may be rewarded a discount on the cost of the retail product or a discount on the cost of services if the user forwards the message to his or her friends via social media or if the user texts an image of the advertisement to the user's contacts. In another embodiment, the same user may receive a higher or different discount on the cost of the retail product or the cost of the services if the user pays a monetary contribution greater than zero (0) dollars to fund the further propagation of the advertisement via projection on an advertising media.

In an embodiment of the disclosure, wherein the advertisement is associated with at least one of a sale of a retail product or an offer for services, and wherein the advertisement offers the receiving party a discount on the cost of the retail product and/or services, the discount may be claimed by the receiving party via an online code or affiliate link.

In an embodiment of the disclosure, wherein the at least one of the interest and interested party comprises a manufacturer or other interested business associated with the advertisement, the method further comprises allowing, using the processor connected to the network, the manufacturer or other interested business to incentivize the receiving party to purchase the at least one of the retail product or service after the advertisement is moved to the user pocketbook.

In an embodiment of the disclosure, wherein the advertisement is associated with at least one of a sale of a retail product or an offer for services and wherein the at least one of the interest or interested party is a manufacturer or interested business, the method further comprises: displaying, using the processor connected to the network, a second icon positioned within or adjacent to the advertisement on the user feed, wherein the second icon or second image indicates the advertisement is a fundable advertisement and the receiving party can become an affiliate marketer for the manufacturer or interested business by paying a monetary contribution to fund further propagation of the advertisement; registering, using the processor and in response to a second user input on the personal electronic device, a second selection by the receiving party which indicates a fixed amount of currency as the monetary contribution; performing, using the processor connected to the network, a transfer of the fixed amount of currency from a first financial account associated with the affiliate marketer to a second financial account designated to hold funds to fund the further propagation of the first advertisement; creating, using the processor and in response to completion of the transfer of the fixed amount of currency, a copy of the advertisement (aka, a second advertisement), wherein the second advertisement appears identical to the initial advertisement and has been tagged with an affiliate marketer code configured to identify the affiliate marketer. The method may further include projecting, via an advertising medium, the second advertisement; displaying on the user profile, via the processor connected to the network, an indication of at least one of an amount of impressions and a value of impressions made upon other users who interact with the second advertisement; and rewarding, via the processor, the affiliate marketer with a reward configured to correspond to at least one of an amount of impressions and a value of impressions. In an embodiment, the rewarding of the affiliate marketer comprises paying the affiliate marketer a commission based on a percentage of the value of the impressions.

In an embodiment, the method includes displaying, using the processor connected to the network, a second fixed amount of currency correlating to the commission earned by the affiliate marketer; registering, using the processor and in response to a fourth user input on the personal electronic device, a selection by the affiliate marketer which indicates a desire to have the second fixed amount of currency transferred to the first financial account associated with the affiliate marketer; and performing, using the processor connect to the network, a transfer of the second fixed amount of currency from a third financial account associated with the manufacturer or interested business to the first financial account associated with the affiliate marketer.

In an embodiment, the rewarding of the affiliate marketer comprises providing the affiliate marketer with at least one of physical product, a discount on a cost of the product, a discount on the services, a monetary sum of currency, and a commission.

In another embodiment, wherein the first advertisement is associated with a job opening for a company, the method further comprises displaying, using the processor connected to the network, a second icon or second image positioned within or adjacent to the first advertisement on the user feed, wherein the second icon or second image indicates the first advertisement is a fundable advertisement and the receiving party can become an affiliate recruiter for the company by paying a monetary contribution to fund further propagation of the first advertisement; registering, using the processor and in response to a second user input on the personal electronic device, a second selection by the receiving party which indicates a fixed amount of currency as the monetary contribution; performing, using the processor connected to the network, a transfer of the fixed amount of currency from a first financial account associated with the affiliate recruiter to a second financial account designated to hold funds to fund the further propagation of the first advertisement; and creating, using the processor and in response to completion of the transfer of the fixed amount of currency, a second advertisement, wherein the second advertisement appears identical to the first advertisement and has been tagged with an affiliate recruiter code configured to identify the affiliate recruiter. The method further comprising projecting, via an advertising medium, the second advertisement; displaying on the user profile, via the processor connected to the network, an indication of at least one of an amount of impressions and a value of impressions made upon other users who interact with the second advertisement; and rewarding the affiliate recruiter, via the processor connected to the network, a reward corresponding to the at least one of the amount of impressions or the value of impressions.

In an embodiment, the affiliate recruiter is financially rewarded based on the number of impressions that resulted in the company hiring someone. In another embodiment, rewarding the affiliate recruiter comprises paying the affiliate recruiter a percentage of a salary of a person hired to fill the job opening if the person hired was one of the other users who interacted with the second advertisement. In various embodiments, the method further comprises: displaying using the processor connected to the network, a second fixed amount of currency correlating to the percentage of the salary earned by the affiliate recruiter; registering, using the processor and in response to a fourth user input on the personal electronic device, a selection by the affiliate recruiter which indicates a desire to have the second fixed amount of currency transferred to the first financial account associated with the affiliate recruiter; and performing, using the processor connect to the network, a transfer of the second fixed amount of currency from a third financial account associated with the company to the first financial account associated with the affiliate marketer.

In an embodiment, the method comprises: creating a non-fungible token (NFT) of the second advertisement which is unique to the affiliate marketer or the affiliate recruiter and owned by the affiliate marketer or affiliate recruiter; and projecting, via the advertising medium, the NFT of the second advertisement.

In another embodiment, the creation of the second advertisement further comprises the operations of: generating a first blockchain code which is used to tag the second advertisement, wherein the first blockchain code is configured to identify an ownership interest of the affiliate marketer; projecting, via the advertising medium, the second advertisement comprising the first blockchain code; and tracking, using the processor and the first blockchain code, impressions made upon other users who interact with the second advertisement.

In an embodiment, the method further comprises: tracking, using the processor and the first blockchain code, the impressions based upon degrees of separation between the affiliate marketer and the other users causing the impressions; sorting, using the processor and the first blockchain code, the impressions into categories; and rewarding, using the processor, the affiliate marketer depending on the impressions in an each of the categories. In an embodiment, wherein the impressions made upon other users who interact with the second advertisement are called primary impressions, the method further comprises: creating, using the processor connected to the network and in response to completion of a second transfer of a third fixed amount of currency from a third financial account associated with a sub-affiliate marketer, a third advertisement; wherein the third advertisement appears identical to the second advertisement and has been tagged with a second block chain code configured to identify an ownership interest of the sub-affiliate marketer; wherein the second blockchain code is inclusive of the first blockchain code and identifies both the affiliate marketer and the sub-affiliate marketer in a blockchain code history which memorializes their respective ownership interests; and wherein the sub-affiliate marketer is one of the other users who interacted with the second advertisement and caused one of the primary impressions relative to the affiliate marketer. The method further includes projecting, via a second advertising medium, the third advertisement comprising the second blockchain code; and tracking, using the processor and the second blockchain code, secondary impressions made upon other users who interact with the third advertisement, wherein the primary impressions comprise a first category of impressions when tracking the impressions of the affiliate marketer, wherein the secondary impressions comprise a second category of impressions when tracking the impressions of the affiliate marketer, and wherein the secondary impressions comprise a first category of impressions when tracking the impressions of the sub-affiliate marketer. In another embodiment of the disclosure, the sub-affiliate marketer is an intervening-affiliate marketer and causes an additional degree of separation to exist between the affiliate marker and a user causing one of the secondary impressions by interacting with the third advertisement, wherein the affiliate marketer receives a first reward correlating to an each of the primary impressions in the first category of impressions, wherein the affiliate marketer receives a second reward correlating to an each of the secondary impressions in the second category of impressions, and wherein the first reward is greater than the second reward.

In an embodiment, the advertisement may be associated with a sale of a retail product that is one of an existing product or a planned product. In an embodiment, wherein the retail product is a planned product and the first advertisement is prospecting for users to pay money to reserve one or more units of the planned product, the affiliate marketer may be rewarded based on a number of planned products that sell to the other users who interact with the second advertisement.

In various embodiments, the system allows a receiving party to choose whether digital or non-digital information belonging to the receiving party is shared with the same or similar interest or interested party as that which is associated with the advertisement that was captured or funded. In an embodiment, non-digital information includes information collected from the receiving party during a creation of the user account of the receiving party, and wherein digital information includes at least one of a name, email address, address of residence, phone number, and personally identifiable information (PII). In another embodiment, digital information includes information collected about the personal electronic device of the receiving party, and wherein the digital information includes at least one of a hashed email address, ip address, cookie identifier, device-id, an identifier for advertising (IFA), and a universally unique identifier (UUID).

Different examples and aspects of the systems and methods are disclosed herein that include a variety of components, features, and functionality. It should be understood that the various examples and aspects of the systems and methods disclosed herein may include any of the components, features, and functionality of any of the other examples and aspects of the systems and methods disclosed herein in any combination, and all of such possibilities are intended to be within the spirit and scope of the present disclosure.

Many modifications and other examples of the disclosure set forth herein will come to mind to one of ordinary skill in the art to which the disclosure pertains having the benefit of the teachings presented in the foregoing descriptions and the associated drawings.

What is claimed is:

1. A method of capturing online advertisements for later viewing or interaction, the method comprising:
displaying, using a processor connected to a network, a first advertisement associated with at least one of an interest and an interested party, wherein the displaying of the first advertisement is on a graphical user interface accessible by a receiving party via a web browser or a mobile application on a personal electronic device;
displaying, using the processor, a first icon or first image positioned within or adjacent to the first advertisement on the graphical user interface that indicates the first advertisement can be saved by the receiving party and moved into a user pocketbook configured to allow future viewing and interaction with the first advertisement;
registering, using the processor and in response to a user input on a personal electronic device, a selection by the receiving party indicating the receiving party wants to move the first advertisement to the user pocketbook; and
moving, using the processor connected to the network, the first advertisement into the user pocketbook in response to registering the user input.

2. The method of claim 1, further comprising creating the user pocketbook, in response to the user input on the personal electronic device, wherein creation of the user pocketbook comprises:
associating on the graphical user interface, using the processor, a user account with the receiving party and a user profile associated with the user account, wherein the receiving party can customize or personalize at least one portion or parameter of the user pocketbook, and
allowing, using the processor, the receiving party to view the first advertisement on a user feed associated with the user pocketbook at least one of immediately and at a later time.

3. The method of claim 2, further comprising:
displaying, using the processor connected to the network and in response to the moving of the first advertisement into the pocketbook, the first advertisement on a user feed of the user pocketbook configured to display all advertisements moved by the receiving party for later viewing; and
allowing, using the processor, the receiving party to select whether they want to receive other advertisements from a same or similar interest or interested party as that which is associated with the first advertisement, wherein the other advertisements from the same or similar interest or interested party are auto-populated within a section of the user feed.

4. The method of claim 3, further comprising
displaying, using the processor connected to the network, a second icon or second image positioned within or adjacent to the first advertisement on the user feed, wherein the second icon or second image indicates the first advertisement is a fundable advertisement and the receiving party can pay a monetary contribution to fund further propagation of the first advertisement;
registering, using the processor and in response to a second user input on the personal electronic device, a second selection by the receiving party which indicates a fixed amount of currency as the monetary contribution;
performing, using the processor connect to the network, a transfer of the fixed amount of currency from a first financial account associated with the receiving party to a second financial account designated to hold funds to fund the further propagation of the first advertisement; and
projecting, via an advertising medium, the first advertisement funded by the receiving party.

5. The method of claim 1, wherein the user input is one of clicking on the first icon or first image and taking a picture of the first icon or first image.

6. The method of claim 2, wherein the first advertisement is associated with at least one of a retail product or a service and wherein the at least one of the interest or interested party is a manufacturer or interested business, the method further comprising:
displaying, using the processor connected to the network, a second icon or second image positioned within or adjacent to the first advertisement on the user feed, wherein the second icon or second image indicates the first advertisement is a fundable advertisement and the receiving party can become an affiliate marketer for the manufacturer or interested business by paying a monetary contribution to fund further propagation of the first advertisement;
registering, using the processor and in response to a second user input on the personal electronic device, a second selection by the receiving party which indicates a fixed amount of currency as the monetary contribution;
performing, using the processor connected to the network, a transfer of the fixed amount of currency from a first financial account associated with the affiliate marketer to a second financial account designated to hold funds to fund the further propagation of the first advertisement;
creating, using the processor and in response to completion of the transfer of the fixed amount of currency, a second advertisement, wherein the second advertisement appears identical to the first advertisement and has been tagged with an affiliate marketer code configured to identify the affiliate marketer;
projecting, via an advertising medium, the second advertisement;
displaying on the user profile, via the processor connected to the network, an indication of at least one of an amount of impressions and a value of impressions made upon other users who interact with the second advertisement; and
rewarding, via the processor, the affiliate marketer with a reward configured to correspond to the at least one of the amount of impressions and the value of impressions.

7. The method of claim 6, wherein the rewarding of the affiliate marketer comprises paying the affiliate marketer a commission based on a percentage of the value of impressions.

8. The method of claim 7, further comprising:
displaying, using the processor connected to the network, a second fixed amount of currency correlating to the commission earned by the affiliate marketer;
registering, using the processor and in response to a fourth user input on the personal electronic device, a selection by the affiliate marketer which indicates a desire to have the second fixed amount of currency transferred to the first financial account associated with the affiliate marketer; and
performing, using the processor connect to the network, a transfer of the second fixed amount of currency from a third financial account associated with the manufacturer or interested business to the first financial account associated with the affiliate marketer.

9. The method of claim 2, wherein the first advertisement is associated with a job opening for a company, the method further comprising:
displaying, using the processor connected to the network, a second icon or second image positioned within or adjacent to the first advertisement on the user feed, wherein the second icon or second image indicates the first advertisement is a fundable advertisement and the receiving party can become an affiliate recruiter for the company by paying a monetary contribution to fund further propagation of the first advertisement;
registering, using the processor and in response to a second user input on the personal electronic device, a second selection by the receiving party which indicates a fixed amount of currency as the monetary contribution;
performing, using the processor connected to the network, a transfer of the fixed amount of currency from a first financial account associated with the affiliate recruiter to a second financial account designated to hold funds to fund the further propagation of the first advertisement;
creating, using the processor and in response to completion of the transfer of the fixed amount of currency, a second advertisement, wherein the second advertisement appears identical to the first advertisement and has been tagged with an affiliate recruiter code configured to identify the affiliate recruiter;
projecting, via an advertising medium, the second advertisement;
displaying on the user profile, via the processor connected to the network, an indication of at least one of an amount of impressions and a value of impressions made upon other users who interact with the second advertisement; and
rewarding the affiliate recruiter, via the processor connected to the network, a reward corresponding to the at least one of the amount of impressions or the value of impressions.

10. The method of claim 9, wherein the rewarding of the affiliate recruiter comprises paying the affiliate recruiter a percentage of a salary of a person hired to fill the job opening if the person hired was one of the other users who interacted with the second advertisement.

11. The method of claim 10, further comprising
displaying, using the processor connected to the network, a second fixed amount of currency correlating to the percentage of the salary earned by the affiliate recruiter;
registering, using the processor and in response to a fourth user input on the personal electronic device, a selection by the affiliate recruiter which indicates a desire to have the second fixed amount of currency transferred to the first financial account associated with the affiliate recruiter; and
performing, using the processor connect to the network, a transfer of the second fixed amount of currency from a third financial account associated with the company to the first financial account associated with the affiliate marketer.

12. The method of claim 6, further comprising:
creating a non-fungible token (NFT) of the second advertisement which is unique to the affiliate marketer and owned by the affiliate marketer; and
projecting, via the advertising medium, the NFT of the second advertisement.

13. The method of claim 6, wherein the creating of the second advertisement further comprises:
generating a first blockchain code which is used to tag the second advertisement, wherein the first blockchain code is configured to identify an ownership interest of the affiliate marketer;
projecting, via the advertising medium, the second advertisement comprising the first blockchain code; and
tracking, using the processor and the first blockchain code, impressions made upon other users who interact with the second advertisement.

14. A system for capturing online advertisements for later viewing, the system comprising:
a processor;
a graphical user interface in communication with the processor; and
at least one non-transitory program storage device in communication with the processor via a network,
wherein the graphical user interface is accessible by a receiving party via a web browser or mobile application on a personal electronic device; and
wherein the processor is configured to communicate with the at least one non-transitory program storage device and the graphical user interface to execute instructions for:
displaying, on the graphical user interface, a first advertisement associated with at least one of an interest and an interested party;
displaying, within or adjacent to the first advertisement on the graphical user interface, a first icon or first image which indicates that the first advertisement can be saved by the receiving party and moved into a user pocketbook configured to allow future viewing and interaction with the first advertisement;
registering, in response to a user input on the personal electronic device, a selection by the receiving party indicating the receiving party wants to move the first advertisement to the user pocketbook; and
moving the first advertisement into the user pocketbook in response to registering the user input.

15. The system of capturing online advertisements as in claim 14, wherein the instructions further comprise creating the user pocketbook, in response to the user input on the personal electronic device, wherein creation of the user pocketbook comprises:
associating, on the graphical user interface, a user account with the receiving party and a user profile associated with the user account, wherein the receiving party can customize or personalize at least one portion or parameter of the user pocketbook, and
allowing the receiving party to view the first advertisement on a user feed associated with the user pocketbook at least one of immediately and at a later time.

16. The system of capturing online advertisements as in claim 15, wherein the instructions further comprise
displaying, in response to the moving of the first advertisement into the pocketbook, the first advertisement on a user feed of the user pocketbook configured to display all advertisements moved by the receiving party for later viewing; and
allowing the receiving party to select whether they want to receive other advertisements from a same or similar interest or interested party as that which is associated with the first advertisement, wherein the other advertisements from the same or similar interest or interested party are auto-populated within a section of the user feed.

17. The system of capturing online advertisements as in claim 16, wherein the instructions further comprise
displaying a second icon or second image positioned within or adjacent to the first advertisement on the user feed, wherein the second icon or second image indicates the first advertisement is a fundable advertisement and the receiving party can pay a monetary contribution to fund further propagation of the first advertisement;
registering, in response to a second user input on the personal electronic device, a second selection by the receiving party which indicates a fixed amount of currency as the monetary contribution;
performing a transfer of the fixed amount of currency from a first financial account associated with the receiving party to a second financial account designated to hold funds to fund the further propagation of the first advertisement; and
projecting, via an advertising medium, the first advertisement funded by the receiving party.

18. The system of capturing online advertisements as in claim 17, wherein the user input is one of clicking on the first icon or first image and taking a picture of the first icon or first image.

19. The system of capturing online advertisements as in claim 17, wherein the instructions further comprise
generating a first blockchain code which is used to tag the second advertisement, wherein the first blockchain code is configured to identify an ownership interest of the affiliate marketer;
projecting, via the advertising medium, the second advertisement comprising the first blockchain code; and
tracking, using the first blockchain code, impressions made upon other users who interact with the second advertisement.

20. A method of capturing online advertisements for later viewing, the method comprising:
displaying, using a processor connected to a network, a first advertisement associated with at least one of an interest and an interested party, wherein the displaying of the first advertisement is on a graphical user interface accessible by a receiving party via a web browser or a mobile application on a personal electronic device;
displaying, using the processor, a first icon or first image positioned within or adjacent to the first advertisement on the graphical user interface that indicates the first advertisement can be saved by the receiving party and moved into a user pocketbook configured to allow future viewing and interaction with the first advertisement;
registering, using the processor and in response to a user input on a personal electronic device, a selection by the receiving party indicating the receiving party wants to move the first advertisement to the user pocketbook;
moving, using the processor connected to the network, the first advertisement into the user pocketbook in response to registering the user input,
wherein the user pocketbook comprises a user account that is associated with the receiving party and a user profile associated with the user account,
wherein the receiving party can customize or personalize at least one portion or parameter of the user pocketbook, and
wherein the first advertisement is associated with at least one of a retail product or a service and the at least one of the interest or interested party is a manufacturer or interested business;
displaying, using the processor connected to the network, a second icon or second image positioned within or adjacent to the first advertisement on the user feed, wherein the second icon or second image indicates the first advertisement is a fundable advertisement and the receiving party can become an affiliate marketer for the manufacturer or interested business by paying a monetary contribution to fund further propagation of the first advertisement;
registering, using the processor and in response to a second user input on the personal electronic device, a second selection by the receiving party which indicates a fixed amount of currency as the monetary contribution;
performing, using the processor connected to the network, a transfer of the fixed amount of currency from a first financial account associated with the affiliate marketer to a second financial account designated to hold funds to fund the further propagation of the first advertisement;
creating, using the processor and in response to completion of the transfer of the fixed amount of currency, a second advertisement, wherein the second advertisement appears identical to the first advertisement and has been tagged with a blockchain code configured to identify an ownership interest of the affiliate marketer;
projecting, via the advertising medium, the second advertisement comprising the blockchain code;
tracking, using the processor and the blockchain code, impressions made upon other users who interact with the second advertisement; and
rewarding, via the processor, the affiliate marketer with a reward configured to correspond to at least one of an amount of impressions and a value of impressions made upon the other users.
